(19) United States
(12) Patent Application Publication
(10) Pub. No.: US 2016/0157202 A1
(43) Pub. Date: Jun. 2, 2016

(54) METHOD OF UTILIZING CONSUMER ELECTRONICS IN WORK MACHINE TRACKING

(71) Applicant: Caterpillar Inc., Peoria, IL (US)

(72) Inventor: Andrew B. Butler, Clayton, NC (US)

(73) Assignee: Caterpillar Inc., Peoria, IL (US)

(21) Appl. No.: 15/016,282

(22) Filed: Feb. 5, 2016

(51) Int. Cl. H04W 64/00

(52) U.S. Cl. CPC H04W 64/00

(57) ABSTRACT

The disclosure provides a method for communicating and determining a geographic location of one or more machines. The method includes configuring a portable device with a location determining module. The location determining module is operated to determine the geographic location of the portable device. Thereafter the portable device detects the one or more machine available for communicating with the portable device. In addition the method includes communicating the determined geographic location, to the one or more machines available for communicating. Additionally, the portable device communicates the determined geographic location to the remote monitoring station, to establish the geographic location of the one or more machines.

### TECHNICAL FIELD

The present disclosure generally relates to work machine in communication with a consumer electronic portable device at a work site. More particularly, the present disclosure relates to determining the location of the work machine by using the consumer electronic portable device.

### BACKGROUND

Many of today's work machines are comprised of complex and sophisticated electrical and mechanical subsystems that rely heavily on various other systems, subsystems, and control elements. Often, these systems and subsystems employ sophisticated hardware, software, and/or firmware to function properly within the work machine. In addition, these systems include one or more electronic components such as, for example, a Global Navigation Satellite System (GNNS) associated with a power source, or other subsystem of a work machine, such as a Global Positioning System (GPS) module.

The proper operation of work machine may depend upon the real-time status monitoring, location detection and diagnostic analysis of the various systems and subsystems of the work machine.

In an effort to efficiently monitor the location of a work machine, various methods have been introduced to collect the location information. For example, U.S. Pat. No. 7,690,565 (the '565 patent), issued to Faoro et al, describes, a method for locating a first machine by collecting machine data from a first machine over a communications network. The machine data for the first machine includes data reflecting operational schedule data When the first machine has been operated and location data for the respective operation times associated with the first machine.

Although the method of the '565 patent may be effective for determining the location of the first machine, but is cost intensive, For example, locating the first machine may comprise (or be configured with) global navigation satellite system (GNSS) receivers to facilitate reporting of location information. Likewise, a power source is required on the first machine to supply power to the GNSS receivers and keep the receivers active.

In addition, should an event occur that causes a potential failure of GNSS or the power source, the location of the machine may not be realized until the service technician accesses the machine. This may result in excessive personnel time and vehicle inactivity costs.

Furthermore, active location monitoring may not be desired by a user and using a GNSS is not cost effective.

The presently disclosed system is directed to overcoming one or more of the problems set forth above.

### BRIEF DESCRIPTION OF THE DRAWINGS

FIG. 1 is a schematic drawing of a communication system embodying a work machine communicating in a work environment, in accordance with the concepts of the present disclosure;

FIG. 2 is a block diagram of an exemplary communication system that may be configured to perform certain functions according to concepts of the present disclosure; and

FIG. 3 is a flowchart depicting an exemplary method of communication of the location of the work machine, in accordance with the concepts of the present disclosure.

### SUMMARY OF THE INVENTION

The disclosure provides a method for communicating and determining geographic location of one or more machines. The method includes steps of configuring a portable device with a location determining module and operating the location determining module to determine the geographic location of the portable device. Further, the method includes, detecting, using the portable device, one or more machines available for communicating with the portable device over a wireless network. In addition the method includes communicating the determined geographic location, to the one or more machines and a remote monitoring station, to establish the geographic location of the one or more machines.

### DETAILED DESCRIPTION

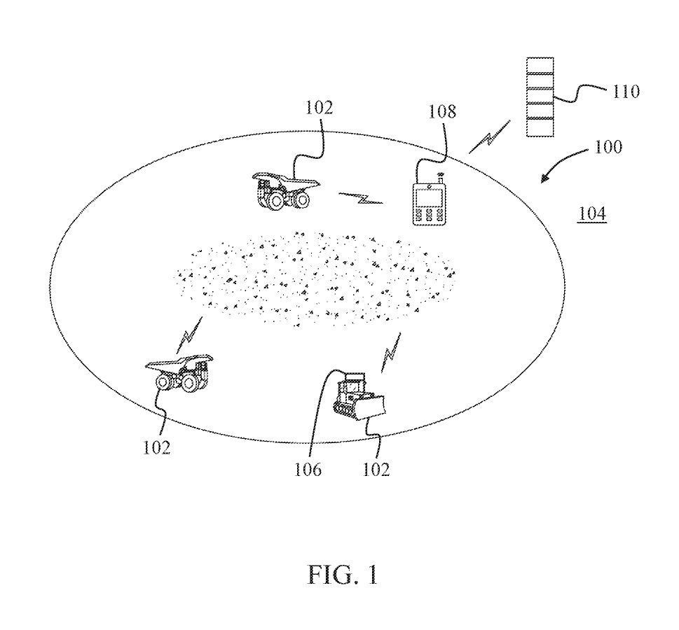

Referring to FIG. 1, a schematic drawing of a communication system 100 embodying one or machines communicating in a work environment 104 is shown. The one or more machine can be a work machine 102. The work machine 102, as the term is used herein, refers to a fixed or mobile machine that performs some type of operation associated with a particular industry, such as mining, construction, farming, etc., and which operates between or within the work environment 104 (e.g., construction site, mine site, power plants, etc.). A non-limiting example of a fixed work machine includes an engine system operating in a plant, off-shore environment (e.g., off-shore drilling platform). Non-limiting examples of mobile work machine includes commercial machines, such as a truck, wheel loader, track-type tractor, a wheeled tractor, cranes, earth moving vehicles, mining vehicles, backhoes, material handling equipment, farming equipment, marine vessels, aircraft, a vehicle, or any other type of machine known in the art, and any type of movable machine that operates in the work environment 104. In a preferred embodiment, the work machine 102 is a track type tractor and the work environment 104 is a mine site.

The communication system 100 includes the work machine 102 including an on-board monitoring module 106, a portable device 108 and a remote monitoring station 110. The portable device 108 is in communication with the on-board monitoring module 106 and the remote monitoring station 110.

The on-board monitoring module 106, as the term is used herein, may represent any type of monitoring component operating in work machine 102 that controls or is controlled by other components or sub-components. For example, an on-board monitoring module 106 may be an Engine Control Module (ECM), a power system control module, a machine control module, an advanced diesel engine manager, an electronic programmable transmission control, and a vital information management system (VIMS), an attachment interface that connects to one or more sub-components, and any other type of device the work machine 102 may use to facilitate monitoring and operations of the work machine 102 during run time or non-run time conditions (i.e., machine engine running or not running, respectively).

In one embodiment, the on-board monitoring module 106 may include a plurality of sensing devices distributed throughout the work machine 102 and configured to gather data from various components, subsystems, or operators of the work machine 102. The sensing devices may be associated with, for example, a work implement, a power source, a transmission, a torque converter, a fluid supply, a suspension system, an operator's controller or input device, and/or other components and subsystems of the work machine 102. These sensing devices may be configured to automatically gather operational information from the components and subsystems of the work machine 102 including implement, engine, and/or work machine speed or location; fluid (i.e., fuel, oil, etc.) pressures, flow rates, temperatures, contamination levels, viscosities, and/or consumption rates, electric current and voltage levels, loading levels payload value, percent of maximum allowable payload limit, payload history, payload distribution, etc.), transmission output ratio, cycle time, grade, performed maintenance and/or repair operations, and other such pieces of information. Additional information may be generated or maintained by the on-board monitoring module 106 such as, for example, time of day, date, and operator information. Each of the gathered pieces of information may be indexed relative to the time, day, date, operator information, or other pieces of information to trend the various operational aspects of the work machine 102. In one embodiment, the on-board monitoring module 106 may be located on the work tools, such a bucket, a blade, a plough, a ripper of the work machine 102. The on-board monitoring module 106 is also adapted to receive configuration messages for the work machine 102, and deliver monitored data to the portable device 108.

The portable device 108, represents a module that is located off-board from work machine 102. The portable device 108 is a system that detects and connects to the on-board monitoring module 106 through a wireline or wireless data link. Further, the portable device 108 may be a computer system including known computing components, such as one or more processors, software, display, and interface devices that operate collectively to perform one or more processes. For example, the portable device 108 can be a consumer electronics device, personal digital assistant, a smart phone, a hand held device, a consumer electronic portable device, and the like. Alternatively, or additionally, the portable device 108 may include one or more communication devices, such a 2.4 GHz RF radio that facilitates the transmission of data to and from the on-board monitoring module 106.

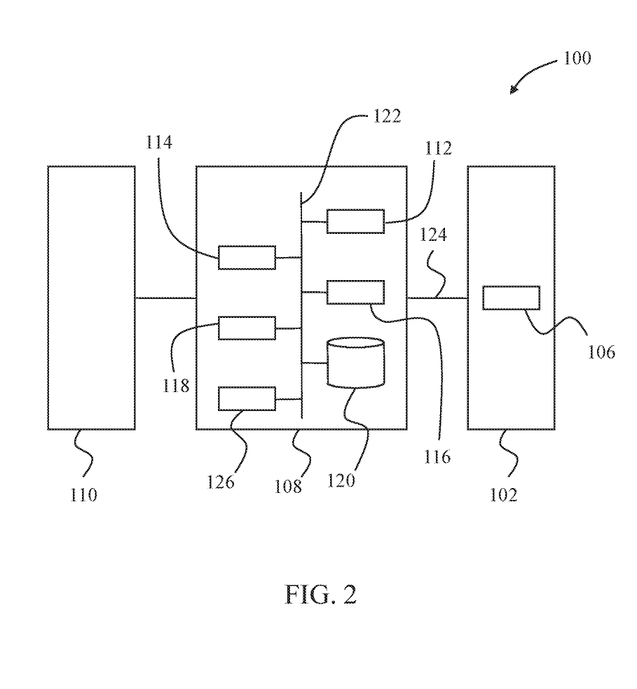

The portable device 108 is further configured with a location determining module 118 (FIG. 2). The portable device 108 may, operate the location determining module to determine the geographic location of the portable device 108. Further, the portable device 108 is configured to communicate the determined geographic location to the on-board monitoring module 106. The location determining module is described in detail in conjunction with FIG. 2.

The portable device 108 is also adapted to communicate the monitored data received from the on-board monitoring module 106 to the remote monitoring station 110. Further, the portable device 108 is configured to share the determined geographic location to the remote monitoring station 110.

The remote monitoring station 110 may include any means for monitoring, recording, storing, indexing, processing, and/or communicating the operational aspects of work machine 102 described above. These means may include components such as, for example, a memory, one or more data storage devices, a central processing unit, or any other components that may be used to run an application. Remote monitoring station 110 may represent one or more computing systems of a business entity associated with work machine 102, such as a manufacturer, dealer, retailer, owner, or any other entity that generates, maintains, sends, and/or receives information associated with the operation of the work machine 102. The one or more computing systems may include, for example, a laptop computer, a work station, a mainframe, and other computing systems known in the art.

In one embodiment of the disclosure, the remote monitoring station 110 may communicate with the on-board monitoring module 106 and monitor the work machine 102. For example, the remote monitoring station 110 may receive monitored data from the on-board monitoring module 106 via the portable device 108.

Referring to FIG. 2, there is shown a block diagram of an exemplary communication system 100 that is configured to perform functions in accordance with preferred embodiments of the present disclosure. The communication system 100 includes the portable device 108 in communication with the on-board. monitoring module 106 and the remote monitoring station 110. The portable device 108 may include a Central Processing Unit (CPU) 112, a network interface module 114, a user interface 116, a location determining module 118, and a storage 120. Further, the portable device 108 includes a communication circuitry 122 providing a communication link between the CPU 112, the network interface module 114, the user interface 116, the location determining module 118, and the storage 120. It is contemplated that the portable device 108 may include additional, fewer, and/or different components than what is listed above. It is understood that the type and number of listed devices are exemplary only and not intended to be limiting.

The CPU 112 may be a processor configured to execute sequences of computer program instructions to perform various processes that will be explained below.

The network interface module 114 may include any device configured to facilitate communication between the portable device 108 and on-board monitoring module 106 or the remote monitoring station 110. The network interface module 114 may include hardware and/or software that enable the portable device 108 to send and/or receive data messages through a wired or wireless communication link 124. The wireless communication link 124 may include satellite, cellular, infrared, Bluetooth, Wireless Fidelity (Wi-Fi), Ethernet, and any other type of wired or wireless communication that enables the exchange of data between portable device 108, the on-board monitoring module 106 and the remote monitoring station 110.

Further, the portable device 108 may interface with a user via the user interface 116. In particular, the user interface 116 may provide a graphics user interface (GUI) to display information to users of the portable device 108. The user interface 116 may be any appropriate type of computer display device or computer monitor. Specific input device may be provided for users to input information into the portable device 108. Example of the user interface 116 may include, but not limited to, a keyboard, a mouse, a touch pad, or other optical or wireless computer input devices.

The portable device 108 also includes the location determining module 118. The location determining module 118 is configured to determine a geographic location of the work machine 102. For example, the location determining module 118 could include a Global Positioning System (GPS), an Inertial Reference Unit (IRU), or any other known locating device. In one embodiment the location determining module 118 communicates with the GPS to determine the geographic location of the portable device 108. The location determining module 118 may be in communication with the network interface module 114 via the communication circuitry 122. The determined geographic location of the work machine 102 may be communicated to the on-board monitoring module 106 and the remote monitoring station 110 using the network interface module 114.

In one embodiment, the portable device 108 may determine the geographic location based on mobile network. In this embodiment, the location determining module 118 may communicate with a mobile base station (not shown) and determine the geographic location and position of the portable device 108, independently or in addition to the information from the GPS.

Further, the portable device includes the storage 120. The storage 120 may embody any appropriate type of mass storage provided to store information that the CPU 112 may need to perform the processes. For example, storage 120 may include one or more hard disk devices, optical disk devices, or other storage devices that provide storage space.

In one embodiment, the determined geographic location from the location determining module 118 and the monitored data from the on-board monitoring module 106 may be stored in the storage 120.

Although aspects of the present disclosure may be described generally as being stored in the storage 120, one skilled in the art will appreciate that these aspects can be stored on or read from types of computer program products or computer-readable media, such as computer chips and secondary storage devices, including hard disks, floppy disks, optical media, CD-ROM, or other forms of RAM or ROM.

Further, the portable device 108 includes a tracking module 126. The tracking module 126 may have several functions. For example, the tracking module 126 may actively scan for work machines in surrounding of the portable device 108. In other words, the tracking module 126 actively scans and tracks for work machines available to communicate with the portable device 108 in the work environment 104.

The tracking module 126 may send signals to identify and connect with a work machine in the surrounding of the portable device 108. For example, the tracking module 126 can send blue tooth signals to determine if a work machine is active in the surrounding is can connect with the portable device 108.

Additionally, the tracking module 126 may receive signals transmitted by a work machine, for example work machine 102 at the work environment 104. The tracking module 126 may track the signals from the work machine 102 or any entity whose position and/or other characteristics are required to be monitored by at least one other entity, for example remote monitoring station 110. Any entity may include any machine, vehicle, asset, infrastructure, or other entity that may be found in a work environment. For example, as shown in FIG. 1, a tracked entity may include the work machine 102, a dump truck, and/or a track type tractor. The signals transmitted by the work machine 102 may include information relating to identification code and various other characteristics of the work machine 102. The tracking module 126 identifies the signals transmitted from the work machine 102 before establishing a connection with the work machine 102.

In one embedment, the tracking module 126 may include various types of tracking antennas (not shown). A tracking antenna may include a dipole antenna, and in another embodiment antenna may include a, blue tooth antenna, and scanning antenna such as a phased array antenna. A scanning antenna may be used to direct a focused beam in a desired direction and to scan the beam over a range of angles.

In one embodiment, a user can install application software on the portable device 108. The application software can include the Central Processing Unit (CPU) 112, a network interface module 114, a user interface 116, a location determining module 118, a storage 120, communication circuitry 122, wireless communication link 124, and the tracking module 126 inbuilt in the application software. For example, the application software can be Vision Link™.

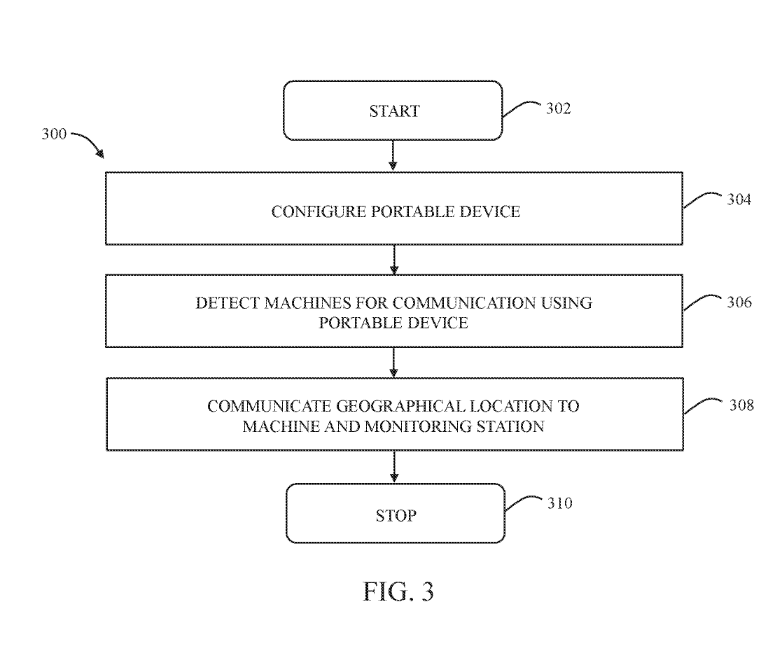

Referring to FIG. 3, there is shown a flowchart 300 that depicts an exemplary method of communicating and determining location of the work machine 102, in accordance with the concepts of the present disclosure.

The method starts at step 302. At Step 304, the method includes, configuring a portable device such as the portable device 108, with a location determining module 118. The method includes setting up the portable device 108 such as a laptop, mobile phone, a smart phone, a Personal Digital Assistant (PDA) or any suitable portable computing device. The location determining module 118 of the portable device 108 can be activated and operated to determine the geographic location of the portable device 108. For example a GPS system of the portable device 108 can connect with a satellite and determine current geographic location of the portable device 108.

In one embodiment, the location determining module 118 can further, determine the geographic location based on information received from a mobile base station tower. In this mode, the portable device 108 can be a mobile device, such as a smart phone, aware of its location based on the information from the mobile base station tower and/or the GPS system it is connected to. For example, the smart phone can communicate with the base station tower to narrow down its geographic location. Additionally, the portable device 108 can be operated to connect with the on-board monitoring module 106 of the work machine 102 and the remote monitoring station 110.

Thereafter, the method proceeds to step 306. At step 306 the method includes, detecting, using the portable device 108, one or more machines available for communicating with the portable device 108 over a wireless network. The portable device 108 can be configured to track its surrounding. In other words, the portable device 108 may include the tracking module 126 to actively search for a machine in a predefined range. For example the portable device 108 can activate a Bluetooth scanner to identify machines available in the range of about 10 meters and able to communicate over RF (radio frequency) radio in the range of 2.5 GHz.

In one embodiment, the tracking module 126 of the portable device 108 can communicate with other machines similar to work machine 102. In another embodiment, the work machine 102 may themselves be tracking various entities at the work environment 104. In one exemplary scenario the work machine 102 may be searching for the portable device 108. The work machine 102 may scan the surroundings to connect with the portable device 108 and execute data transfer. In certain embodiments, however, these types of communications between portable device 108 and the work machine 102 may be accomplished by using one or more antennas or any other suitable devices.

Thereafter, the method proceeds to step 308. At step 308, the determined geographic location of the work machine 102 is communicated to the detected work machine 102. The determined geographic location is processed by the work machine 102. The determined geographic location is also associated with the data monitored by the on-board monitoring module 106 for further processing. The determined geographic location is associated with the machine parameters as monitored by the on-board monitoring module 106. For example, on-board monitoring module 106 may be located and may be monitoring the work tool associated with work machine 102. The on-board monitoring module 106 is monitoring, the hours of usage and remaining life time of the work tool. The monitored data of the work tool is associated with the determined geographic location such that the location of the work tool can be determined. Also, it can be determined what material the work tool may be handling based on the determine location. This information can be processed to estimate the service or maintenance scheduling.

In addition, the determined geographic location is communicated to the remote monitoring station 110. As described above, the monitored data by the on-board monitoring module 106 is associated with the geographic location. The monitored data along with the geographic location may be communicated to the remote monitoring station 110. The remote monitoring station 110 can process the monitored data and the geographic location to determine functionality with the machine integration, utilization, coaching, and maintenance features.

Thereafter, the method terminates at step 310.

### INDUSTRIAL APPLICABILITY

In operation, a user of the portable device 108 can activate the location determining module 118 of the portable device 108 using the user interface 116. The location determining module 118 connects with the GPS and determines the geographic location of the portable device 108. Further, tracking module 126 is activated by the user to scan a work machine 102 in surrounding work environment 104. For example, the user may use the user interface 116 to activate a blue tooth antenna to scan work machines in a range of about 10 meters. The tracking module 126 scans for machines in the predefined range and able to connect with the portable device. Once the tracking module 126 identifies a machine available for communication, the network interface module 114 establishes the wireless communication link 124 with the work machine 102. Thereafter, the portable device 108 communicates the determined geographic location to the work machine 102. Furthermore, the work machine 102 may transmit the monitored data to the portable device 108. For example the on-board monitoring module 106 of the work machine 102 may monitor a fuel gauge of the work machine 102. Thereafter, the work machine 102 may transmit the current fuel consumption data to the portable device 108.

Thereafter, the portable device 108 establishes the wireless communication link 124 with the remote monitoring station 110. The portable device 108 transmits the determined geographic location, and the fuel gauge data as provided by the work machine 102, to the remote monitoring station 110 for further processing. The remote monitoring station 110 can process the received information by associating the determined geographic location with the fuel gauge data. The remote monitoring station 110 may thereby dispatch a fuel truck as needed to the work machine 102.

In another example, the on-board monitoring module 106 is located on the work tool and may be configured to monitor a blade attached with work machine 102. The on-board monitoring module 106 can monitor the wear condition and load forces being applied to the blade. The data on the wear condition and the load forces can be associated with the determined geographic location and transmitted to the remote monitoring station 110. The remote monitoring station 110 can process the monitored data and the determined geographic location to understand the usage of the blade and may schedule maintenance or predict failure rate.

In one embodiment, the remote monitoring station 110 may transmit back configuration message for the work machine 102. In this scenario, the portable device 108 will transmit the configuration message to the work machine 102. For example, the remote monitoring station 110 may communicate a signal to control engine speed of the work machine 102. The signal from the remote monitoring station 110 is communicated to the work machine 102, through the portable device 108, for further action.

Hence, the portable device 108 determines the geographic location of one or more machines and acts as a communication channel between the work machine 102 and the remote monitoring station 110, without the work machine 102 having need for a coordinator or location detection system on board.

It should be understood that the above description is intended for illustrative purposes only and is not intended to limit the scope of the present disclosure in any way. Thus, one skilled in the art will appreciate that other aspects of the disclosure may be obtained from a study of the drawings, the disclosure, and the appended claim.

What is claimed is:

1. A method for communicating and determining a geographic location of one or more machines, the method comprising:
configuring a portable device with a location determining module and operating the location determining module to determine the geographic location of the portable device;
detecting, using the portable device, one or more machines available for communicating with the portable device over a wireless network; and
communicating the geographic location, to the one or more machines and a remote monitoring station, to establish the geographic location of the one or more machines.
